(19) United States
(12) Patent Application Publication
(10) Pub. No.: US 2026/0196952 A1
(43) Pub. Date: Jul. 9, 2026

(54) SYSTEM

(71) Applicant: NIDEC CORPORATION, Kyoto (JP)

(72) Inventor: Hideyuki TAKEMOTO, Kyoto (JP)

(21) Appl. No.: 19/132,822

(22) PCT Filed: Nov. 21, 2023
(86) PCT No.: PCT/JP2023/041742

§ 371 Date: May 26, 2025

(30) Foreign Application Priority Data
Nov. 29, 2022 (JP) 2022-189968

(51) Int. Cl. H02P 5/74; H02P 23/14

(52) U.S. Cl. CPC H02P 5/74; H02P 23/14

(57) ABSTRACT

A stably operable system is provided. A system includes motors, and a detection unit, a communication unit, and a drive unit corresponding to each of the motors. The detection unit detects the state of the own motor. The own motor is one of the motors corresponding to the detection unit. The communication unit transmits the state of the own motor to another communication unit, and receives the state of the other motor from the other communication unit. The other motor is one of the motors corresponding to the other communication unit. The drive unit rotates the own motor at a rotation speed based on the state of the other motor received by the communication unit corresponding to the drive unit.

### CROSS-REFERENCE TO RELATED APPLICATIONS

This is the U.S. national stage of application No. PCT/JP2023/041742, filed on Nov. 21, 2023, and priority under 35 U.S.C. § 119 (a) and 35 U.S.C. § 365 (b) is claimed from Japanese Patent Application No. 2022-189968, filed on Nov. 29, 2022.

### FIELD OF THE INVENTION

The present disclosure relates to a system including a plurality of motors.

### BACKGROUND

A system as background art includes a plurality of fan motors. Each of the plurality of fan motors incorporates a first microcomputer having a communication function. The system further includes a second microcomputer having a communication function. Each of the first microcomputers receives an instruction of a rotation speed, forward/reverse rotation, on/off, or the like from the second microcomputer. Each of the first microcomputers controls the operation of the corresponding fan motor in response to the instruction. Each of the first microcomputers can detect a state of a fan motor incorporated therein and notify the second microcomputer of the detected state.

However, the background art merely describes notifying the second microcomputer of the state of each fan motor. Therefore, when the performance of a certain fan motor in the system deteriorates, the performance of the entire system deteriorates. That is, there is a problem that stable operation is difficult in the system of the related art.

### SUMMARY

A system according to one aspect of the present disclosure includes a plurality of motors, and a detection unit, a communication unit, and a drive unit corresponding to each of the plurality of motors. The detection unit detects the state of the own motor. The own motor is one of the plurality of motors corresponding to the detection unit. The communication unit transmits the state of the own motor to another communication unit, and receives the state of the other motor from the other communication unit. The other motor is one of the plurality of motors corresponding to the other communication unit. The drive unit rotates the own motor at a rotation speed based on the state of the other motor received by the communication unit corresponding to the drive unit.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram illustrating a configuration of an information processing apparatus including a system according to an embodiment of the present disclosure;

FIG. 2 is a diagram illustrating a detailed configuration of each fan illustrated in FIG. 1;

FIG. 3 is a flowchart illustrating exemplary operation of a control unit illustrated in FIG. 1;

FIG. 4 is a flowchart illustrating exemplary operation of a processing unit illustrated in FIG. 2;

FIG. 5 is a flowchart illustrating detailed processing of step S211 illustrated in FIG. 4;

FIG. 6 is a flowchart illustrating a modification of the detailed process of step S211 illustrated in FIG. 4;

FIG. 7 is a diagram illustrating a first configuration example of a series circuit, a first ADC, and a second ADC in the system illustrated in FIG. 1;

FIG. 8 is a flowchart illustrating individual address setting processing in the system 100 illustrated in FIG. 7; and

FIG. 9 is a diagram illustrating a second configuration example of a series circuit, a first ADC, and a second ADC in the system illustrated in FIG. 1.

### DETAILED DESCRIPTION

Hereinafter, an embodiment of the present disclosure will be described with reference to the drawings. In the drawings, the same or corresponding parts are denoted by the same reference numerals, and the description will not be repeated.

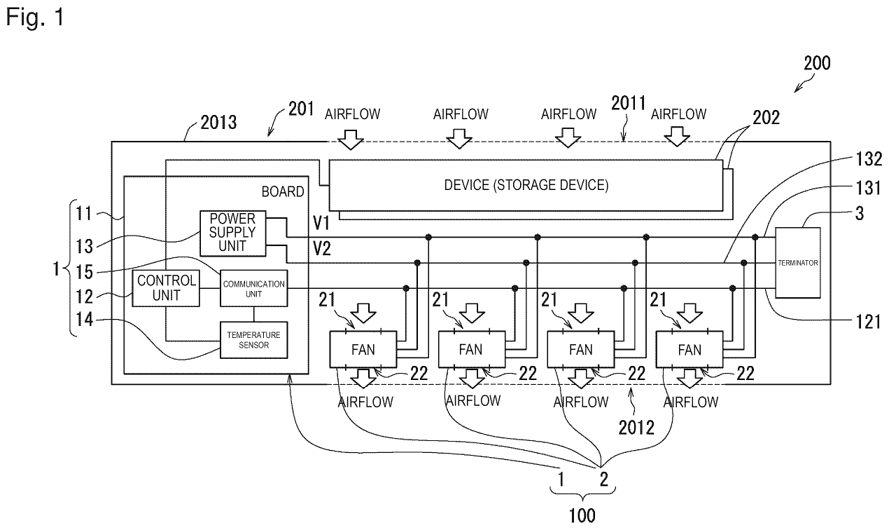

FIG. 1 is a diagram illustrating a configuration of an information processing apparatus 200 including a system 100 according to an embodiment. The information processing apparatus 200 is, for example, a blade server apparatus. As illustrated in FIG. 1, the information processing apparatus 200 includes a housing 201, a plurality of devices 202, and the system 100.

The housing 201 has a substantially rectangular parallelepiped outer shape and has openings 2011 and 2012. The openings 2011 and 2012 are formed at different positions in the housing 201. The opening 2011 functions as an intake port, and the opening 2012 functions as an exhaust port. The housing 201 further includes a frame 2013.

Each device 202 is, for example, a so-called blade, and functions as a single computer device. Specifically, each device 202 includes a microprocessor (not illustrated), a main memory (not illustrated), and a storage device (not illustrated). The storage device is typically a hard disk drive. Each device 202 is attached to the frame 2013. Specifically, each device 202 is located farther from the opening 2012 than the plurality of fans 2 (described later) in the housing 201.

In the embodiment, the information processing apparatus 200 is a blade server apparatus. However, the present invention is not limited thereto, and the information processing apparatus 200 may be, for example, a server device or a RAID device. RAID is an acronym for Redundant Array of Inexpensive Disks. In the case of a server device or a RAID device, each device 202 is a storage device.

The system 100 is an air cooling system in the housing 201. The system 100 includes a circuit board 1 and a plurality of fans 2. The number of fans 2 is four.

The circuit board 1 includes a board 11, a control unit 12, a power supply unit 13, and a temperature sensor 14. The control unit 12, the power supply unit 13, and the temperature sensor 14 are mounted on the board 11.

The control unit 12 typically includes a microprocessor (not illustrated) and a main memory (not illustrated). The microprocessor executes the program stored in the main memory. The control unit 12 is network-connected to each fan 2 by, for example, a data line 121. In the embodiment, the control unit 12 and each fan 2 are connected by a bus-type network topology. Note that the network topology may be of a star type or a ring type. The control unit 12 and each fan 2 may be connected by a wireless network.

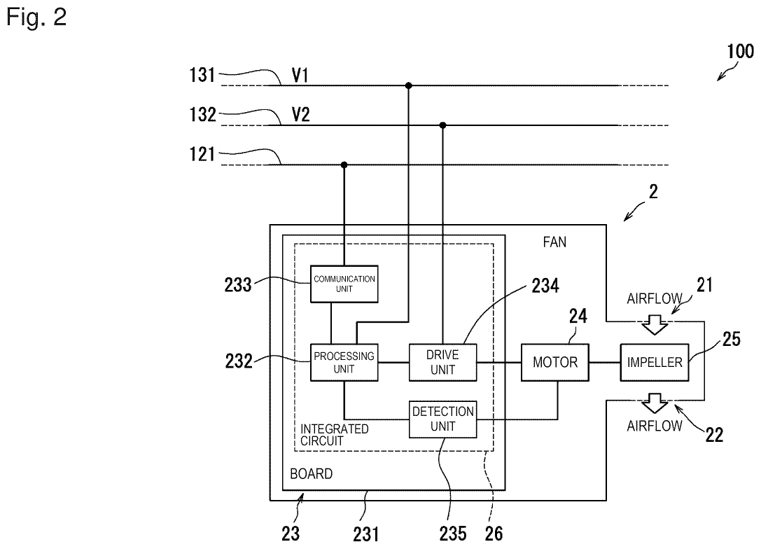

The power supply unit 13 is electrically connected to each fan 2 by power supply lines 131 and 132. The power supply unit 13 receives supply of an AC voltage from, for example, a commercial power supply or an uninterruptible power supply (not illustrated) under the control of the control unit 12. The power supply unit 13 generates DC voltages V1 and V2 for operating each fan 2 from the supplied AC power. The DC voltage V2 is larger than the DC voltage V1. Specifically, the DC voltage V1 is supplied to each fan 2 through the power supply line 131 in order to operate a processing unit 232 and a communication unit 233 (see FIG. 2) of each fan 2. The DC voltage V2 is supplied to a drive unit 234 of each fan 2 through the power supply line 132 in order to rotate the motor 24 (see FIG. 2) of each fan 2.

In addition to the DC voltages V1 and V2, the power supply unit 13 may also generate a voltage (not illustrated) for operating each device 202. That is, the plurality of devices 202 share the power supply unit 13.

A terminator 3 is provided at one end of each of the data line 121 and the power supply lines 131 and 132. The terminator 3 includes a termination resistor of the data line 121, and the like.

The temperature sensor 14 is located near the opening 2012 in the housing 201. Note that the position of the temperature sensor 14 may be either inside or outside the housing 201. The temperature sensor 14 outputs a signal (hereinafter, referred to as a “temperature signal”) indicating the ambient temperature of the temperature sensor 14 to the control unit 12.

The communication unit 15 is a communication interface conforming to a predetermined communication protocol. The predetermined communication protocol is not particularly limited, but is an inter-integrated circuit (I2C) in the embodiment. Although not illustrated, the communication unit 15 operates by the DC voltage V1. The communication unit 15 receives a data packet transmitted through the data line 121 and transfers the data packet to the main memory of the control unit 12. Furthermore, the communication unit 15 transmits the data passed by the control unit 12 to the data line 121 as a data packet.

The plurality of fans 2 are linearly arranged in the housing 201. Each fan 2 has a suction port 21 and a discharge port 22. The plurality of fans 2 are disposed such that air flows between each of the discharge ports 22 and the opening 2012. Specifically, each discharge port 22 faces the opening 2012.

FIG. 2 is a diagram illustrating a detailed configuration of each fan 2 illustrated in FIG. 1. Since the fans 2 have substantially the same shape and specification, FIG. 2 illustrates a detailed configuration of one fan 2. In addition, the term “substantially the same” does not mean only completely the same thing, but also generally the same thing with a tolerance or a range of slight differences.

As illustrated in FIG. 2, each fan 2 includes a circuit board 23, a motor 24, and an impeller 25. That is, the system 100 includes a plurality of motors 24. The circuit board 23 includes a processing unit 232, a communication unit 233, a drive unit 234, and a detection unit 235 on a board. The processing unit 232, the communication unit 233, the drive unit 234, and the detection unit 235 are mounted on a board 231. The board 231 is an example of a “second board” in the present disclosure. Therefore, the system 100 includes the processing unit 232, the communication unit 233, the drive unit 234, and the detection unit 235 corresponding to each of the plurality of motors 24. The system 100 also includes the impeller 25 corresponding to each of the plurality of motors 24.

The processing unit 232 typically includes a microprocessor (not illustrated) and a main memory (not illustrated). The processing unit 232 operates by the DC voltage V1 supplied through the power supply line 131. The microprocessor operates according to a program stored in the main memory.

The communication unit 233 may be similar to the communication unit 15. Therefore, the description of the communication unit 233 is simplified. The communication unit 233 receives a data packet transmitted through the data line 121 and transfers the data packet to the main memory of the processing unit 232. In addition, the communication unit 233 converts the data passed from the processing unit 232 provided in the same fan 2 into a data packet, and sends the data packet to the data line 121.

Hereinafter, “provided in the same fan 2” may be referred to as “corresponding”. Therefore, for example, the processing units 232 provided in the same fan 2 may be described as “corresponding processing units 232”, and the motor 24 provided in the same fan 2 may be described as “corresponding motor 24”.

When the control unit 12 and each fan 2 are connected by a wireless network, the predetermined communication protocol is a wireless communication standard such as IEEE802.11. In this case, the communication unit 15 and the communication unit 233 operate by the DC voltage V1, receive a data packet transmitted through a wireless transmission path (not illustrated), and transfer the data packet to the main memories of the control unit 12 and the processing unit 232, respectively. Furthermore, the communication unit 15 and the communication unit 233 each convert data transferred from the control unit 12 and the processing unit 232 into a data packet, and transmit the data packet to a wireless transmission path (not illustrated). As a result, since the data line 121 is unnecessary in the housing 201, the space in the housing 201 is effectively used.

The drive unit 234 is typically an H-bridge circuit. The corresponding motor 24 is connected to the drive unit 234. The drive unit 234 includes four switching elements, a power supply terminal, and a grant terminal in order to rotate the corresponding motor 24. Each switching element is, for example, a semiconductor power transistor such as a metal oxide semiconductor field effect transistor. A pulse-width modulated signal (hereinafter, referred to as a “PWM signal”) is input from the processing unit 232 to the gate of each switching element. As a result, on/off of each switching element is controlled, and the DC voltage V2 is chopped by the PWM signal according to the duty ratio of the PWM signal. As a result, the rotation direction and the rotation speed of the motor 24 are controlled.

Each of the plurality of motors 24 includes a motor body and an output shaft. Each motor body generates a rotating magnetic field under the control of the corresponding drive unit 234. The output shaft is rotated by a rotating magnetic field generated by the corresponding motor body.

Each of the plurality of impellers 25 is attached to an output shaft of the corresponding motor 24. Therefore, each impeller 25 rotates together with the output shaft of the corresponding motor 24. As a result, the air around the suction port 21 is sucked into the fan 2 from the suction port 21. The air in the fan 2 is discharged from the discharge port 22 to the outside of the fan 2. As a result, an airflow from the opening 2011 to the opening 2012 is generated in the housing 201. As a result, heat in the housing 201 is discharged to the outside of the housing 201.

Each of the plurality of detection units 235 detects the state of the corresponding motor 24. Here, the corresponding motor 24 is an example of the “own motor” in the present disclosure. Hereinafter, the corresponding motor 24 may be referred to as “own motor 24”. In the embodiment, each detection unit 235 is, for example, a rotary encoder. In this case, each detection unit 235 detects the rotation speed of the output shaft of the own motor 24 as the state of the own motor 24. Each detection unit 235 outputs a state value, which is a value indicating the state of its own motor 24, to the corresponding processing unit 232. As a result, the processing unit 232 can determine whether or not there is an abnormality in the rotation speed of each motor 24.

Furthermore, as illustrated in FIG. 2, the detection unit 235, the communication unit 233, the drive unit 234, and the processing unit 232 provided in the same fan 2 are preferably incorporated in the same integrated circuit 26. As a result, the detection unit 235, the communication unit 233, the drive unit 234, and the processing unit 232 can be easily mounted on the board 231. In addition, the fan 2 and thus the system 100 can be downsized.

Next, operations of the control unit 12 and the communication unit 15 (see FIG. 1) and the processing units 232 and the corresponding communication unit 233 (see FIG. 2) in the system 100 will be described with reference to FIGS. 1 to 5.

During operation of the system 100, the control unit 12 (see FIG. 1) acts as a master in the I2C. Each fan 2, that is, each processing unit 232 (see FIG. 2) functions as a slave in the I2C. In addition, the control unit 12 stores the individual address and the broadcast address of each fan 2 in its own memory. The individual address is address information uniquely assigned to each fan 2, that is, the corresponding processing unit 232. The broadcast address is address information for simultaneously distributing data to all the fans 2 connected to the network. Each processing unit 232 stores the individual address of the fan 2 in which it is provided, in its own register.

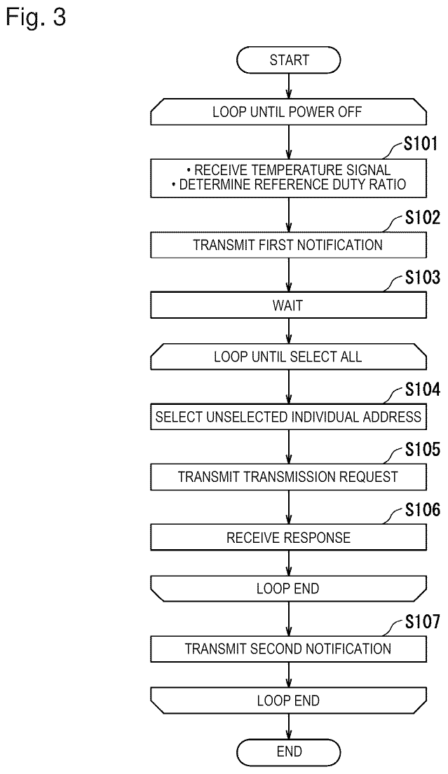

FIG. 3 is a flowchart illustrating an example of operation of the control unit 12 and the communication unit 15 illustrated in FIG. 1. As illustrated in FIG. 3, after starting the information processing apparatus 200, in step S101, the control unit 12 receives a temperature signal from the temperature sensor 14 in order to bring the temperature in the housing 201 close to the set temperature. The control unit 12 determines a duty ratio (hereinafter, referred to as “reference duty ratio”) for compensating for the deviation by PID control based on the deviation (temperature difference) between the temperature indicated by the received temperature signal and the target temperature in the housing 201.

Next, in step S102, the control unit 12 passes the broadcast address, the reference duty ratio, and read/write information to the communication unit 15 as a “first notification”. The read/write information is information indicating either “read” or “write”. When “read” is indicated, the master is the data reception side. When “write” is indicated, the master is the data transmission side. In step S102, “write” as read/write information is passed to the communication unit 15. The communication unit 15 sequentially sends the broadcast address, the read/write information, and the reference duty ratio (that is, the first notification) to the data line 121 bit by bit.

Next, in step S103, the control unit 12 waits for a predetermined time. While waiting, the impeller 25 starts rotation in each of all the fans 2, and eventually rotates steadily. The detailed operation of each fan 2 will be described later.

Next, in step S104, the control unit 12 selects one unselected individual address from all the individual addresses stored in the memory. The control unit 12 sets the individual address selected in step S104 to “selected”.

Next, in step S105, the control unit 12 passes the individual address selected in step S104 and the read/write information indicating “read” to the communication unit 15, as a “transmission request” to the fan 2 specified by the individual address. The communication unit 15 sends the transmission request to the data line 121.

Next, in step S106, the control unit 12 receives a response to the transmission request output in step S105. The response includes a value (hereinafter, referred to as “state value”) indicating the state of the own motor 24. The own motor 24 is the motor 24 included in the fan 2 specified by the individual address selected in step S104. The control unit 12 stores the state value included in the reception response, in the memory.

The control unit 12 repeats a series of processing from step S104 to step S106 until all the individual addresses have been selected in step S104. As a result, the state values of all the fans 2 are stored in the memory of the control unit 12.

Next, in step S107, the control unit 12 passes the broadcast address, the state values of all the fans 2, and the read/write information indicating “write”, to the communication unit 15 as a “second notification”. The communication unit 15 sends the second notification to the data line 121.

Next, after completion of step S107, the control unit 12 waits for an execution timing of the next step S101.

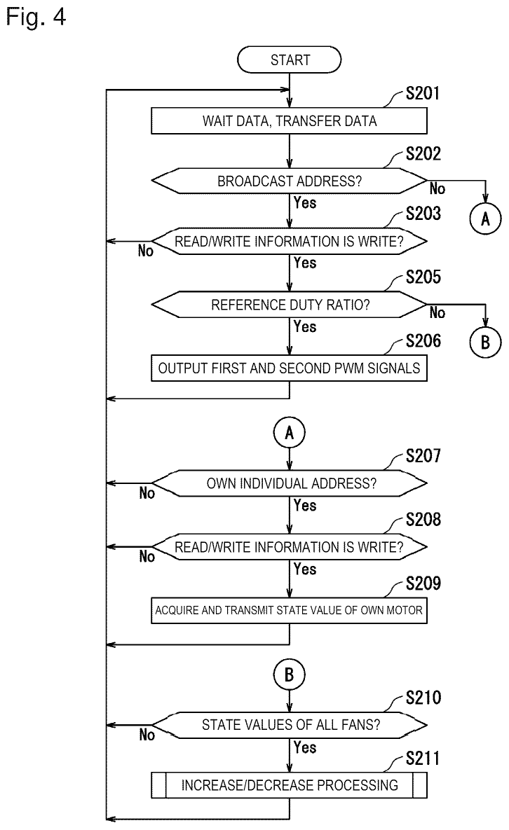

FIG. 4 is a flowchart illustrating exemplary operation of the processing unit 232 and the communication unit 233 illustrated in FIG. 2. After starting the information processing apparatus 200, as illustrated in FIG. 4, in step S201, the communication unit 233 waits for data reception from the data line 121. In response to receiving the data, the communication unit 233 transfers the received data to the memory of the processing unit 232. The processing unit 232 executes the processing in and after step S202 with the data in the memory as a processing target.

In step S202, the processing unit 232 determines whether or not the address information included in the processing target is a broadcast address. When it is determined that the address is the broadcast address (Yes in step S202), step S203 is executed. On the other hand, when it is determined that the address is not the broadcast address (No in step S202), step S207 is executed.

In step S203, the processing unit 232 determines whether or not the read/write information to be processed is “write”. When it is determined not to be “write” (No in step S203), step S201 is executed again. On the other hand, when it is determined to be “write” (Yes in step S203), step S205 is executed.

In step S205, the processing unit 232 determines whether or not the data following the read/write information is the reference duty ratio. When it is determined that the data is the reference duty ratio (Yes in step S205), it is determined that the first notification is received, and step S206 is executed. On the other hand, when it is determined that the data is not the reference duty ratio (No in step S206), step S210 is executed.

In step S206, the processing unit 232 generates a first PWM signal and a second PWM signal as PWM signals. The first PWM signal has a reference duty ratio. On the other hand, the duty ratio of the second PWM signal is zero. The processing unit 232 applies the first PWM signal to the gates of two predetermined switching elements in the drive unit 234, and applies the second PWM signal to the gates of the remaining switching elements. As a result, the DC voltage V2 is chopped by the duty ratio of the first PWM signal, and the rotation direction and the rotation speed of the impeller 25 are controlled. As a result, the temperature in the housing 201 can be brought close to the set temperature. After step S206 is executed, step S201 is executed again.

Note that the series of processing from steps S201 to S206 is executed within the waiting time of step S103 (see FIG. 3) in the control unit 12.

In step S207, the processing unit 232 determines whether or not the address information included in the processing target is its own individual address. When it is determined that the address is not its own individual address (No in step S207), step S201 is executed again. On the other hand, when it is determined that the address is its own individual address (Yes in step S207), step S208 is executed.

In step S208, the processing unit 232 determines whether or not the read/write information to be processed is “read”. When it is determined not to be “read” (No in step S208), step S201 is executed again. On the other hand, when it is determined to be “read” (Yes in step S208), step S209 is executed.

In step S209, the processing unit 232 determines that the processing target is a transmission request, and acquires a state value (that is, the rotation speed of the own motor 24) detected by the corresponding detection unit 235. The processing unit 232 passes the acquired state value to the communication unit 233 as a response to the transmission request. The communication unit 233 sends the received response to the data line 121. The response is received by the control unit 12 in step S106 (see FIG. 3). As described above, the control unit 12 transmits the state values of all the fans 2 to the processing units 232 of all the fans 2 by the second notification. In other words, in step S209, the communication unit 233 transmits the state value of the own motor 24 to the other communication unit 233 through the control unit 12 and the communication unit 15. After step S209 is executed, step S201 is executed again.

In step S210, the processing unit 232 determines whether or not the data following the read/write information is the state values of all the fans 2. When it is determined that the data is not the state values of all the fans 2 (No in step S210), step S201 is executed again. On the other hand, when it is determined that the data is the state values of all the fans 2 (Yes in step S210), it is determined that the second notification has been received, and step S211 is executed. That is, in the case of Yes in step S210, the communication unit 233 receives the state value of the other motor 24 from the other communication unit 233 via the control unit 12 and the communication unit 15. The other motor 24 is a motor 24 corresponding to the other communication unit 233, and is a motor 24 other than the own motor 24.

In step S211, based on the state value of the other motor 24 included in the second notification and the state value of the own motor 24, the processing unit 232 executes processing for increasing or decreasing the rotation speed of the corresponding motor 24 (“increase/decrease processing” in the drawing). As a result, the system 100 can be operated stably.

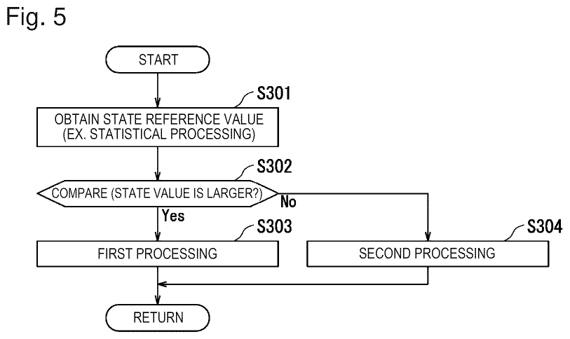

FIG. 5 is a flowchart illustrating detailed processing of step S211 illustrated in FIG. 4. As illustrated in FIG. 5, in step S301, the processing unit 232 obtains a state reference value. The state reference value is determined based on statistical processing on the state value of the other motor 24 included in the second notification. The statistical processing is typically average processing performed on the state value of the other motor 24. In this case, the state reference value is an average value. The state reference value may be a median value of the state values of the other motors 24, besides the average value.

Next, in step S302, the processing unit 232 compares the state value of the own motor 24 with the state reference value. As a result of the comparison, when it is determined that the state value is larger than the state reference value (Yes in step S302), step S303 is executed. On the other hand, when it is determined that the state value is smaller than the state reference value (No in step S303), step S304 is executed.

In step S303, the processing unit 232 executes first processing for reducing the rotation speed of the own motor 24. In this case, the own motor 24 rotates at a relatively high rotation speed. If this situation is prolonged, the progress of deterioration of the own motor 24 is accelerated. Therefore, by reducing the rotation speed of the own motor 24 by the first processing, the system 100 can be stably operated for a long period of time.

In the first processing, more specifically, the processing unit 232 generates a third PWM signal and the above-described second PWM signal as PWM signals. The third PWM signal has a third duty ratio smaller than the reference duty ratio by a predetermined value. The processing unit 232 applies the third PWM signal to the gates of two predetermined switching elements (described above) in the corresponding drive unit 234, and applies the second PWM signal to the gates of the remaining switching elements. Therefore, the corresponding drive unit 234 rotates the corresponding motor 24 (that is, the own motor 24) at a rotation speed based on the state value of the other motor 24 received by the corresponding communication unit 233. By reducing the rotation speed of the own motor 24 by the first processing, the system 100 can be stably operated for a long period of time.

In step S304, the processing unit 232 executes second processing for increasing the rotation speed of the own motor 24. In this case, the own motor 24 rotates at a relatively low rotation speed. By the first processing and the second processing, variations in the rotation speed of the plurality of motors 24 are suppressed. As a result, the system 100 can be operated stably.

In the second processing, more specifically, the processing unit 232 generates a fourth PWM signal and the above-described second PWM signal as PWM signal. The fourth PWM signal has a fourth duty ratio larger than the reference duty ratio by a predetermined value. The processing unit 232 applies the fourth PWM signal to the gates of two predetermined switching elements (described above), and applies the second PWM signal to the gates of the remaining switching elements. Therefore, also in step S304, the corresponding drive unit 234 rotates the corresponding motor 24 (that is, the own motor 24) at a rotation speed based on the state value of the other motor 24 received by the corresponding communication unit 233. As a result, the system 100 can be operated stably.

After executing one of steps S303 and S304, the processing unit 232 exits the process of FIG. 5 (that is, step S211 in FIG. 4) and re-executes step S201.

In the embodiment, the impeller 25 is attached to the output shaft of each motor 24. In this case, the cooling performance of the system 100 can be maintained by the first processing and the second processing.

At least one of the plurality of processing units 232 may be referred to as a “first processing unit 232”. At least one of the plurality of processing units 232 excluding the first processing unit 232 may be referred to as a “second processing unit 232”.

The first processing unit 232 executes the first processing (step S303 in FIG. 5) for reducing the rotation speed of the own motor 24. The third PWM signal output in the first processing has a third duty ratio smaller than the reference duty ratio by a predetermined value. In this case, the second processing unit 232 executes the second processing (step S304 in FIG. 5) for increasing the rotation speed of the own motor 24. The fourth PWM signal output in the second processing has a fourth duty ratio larger than the reference duty ratio by a predetermined value. Therefore, the rotation speed of the motor 24 increased by the second processing unit 232 is determined based on the rotation speed of the motor 24 decreased by the first processing unit 232. As a result, the total rotation speed of the plurality of fans 2 does not greatly vary before and after the execution of step S211. That is, the temperature in the housing 201 does not excessively rise. As a result, the system 100 can be operated stably.

In the embodiment, the state value is the rotation speed. However, the present invention is not limited thereto, and the state value may be any of the current flowing through the own motor 24, the vibration of the own motor 24, and the temperature of the own motor 24. That is, each of the detection units 235 may detect any one of the current flowing through the own motor 24, the vibration of the own motor 24, and the temperature of the own motor 24.

Specifically, when the state value (that is, current value) is larger than the state reference value (current reference value), the corresponding motor 24 is in an overload state. Therefore, the processing unit 232 executes the first processing (step S303 in FIG. 5). On the other hand, when the current value is smaller than the current reference value, the processing unit 232 executes the second processing (step S304 in FIG. 5).

When the state value (that is, the temperature) is larger than the state reference value (temperature reference value), the corresponding motor 24 may travel faster. Therefore, the processing unit 232 executes the first processing (step S303 in FIG. 5). On the other hand, when the temperature is lower than the temperature reference value, the processing unit 232 executes the second processing (step S304 in FIG. 5).

When the state value (that is, vibration value) is larger than the state reference value (vibration reference value), the corresponding motor 24 deteriorates faster. Therefore, the processing unit 232 executes the first processing (step S303 in FIG. 5). On the other hand, when the vibration value is smaller than the vibration reference value, the processing unit 232 executes the second processing (step S304 in FIG. 5).

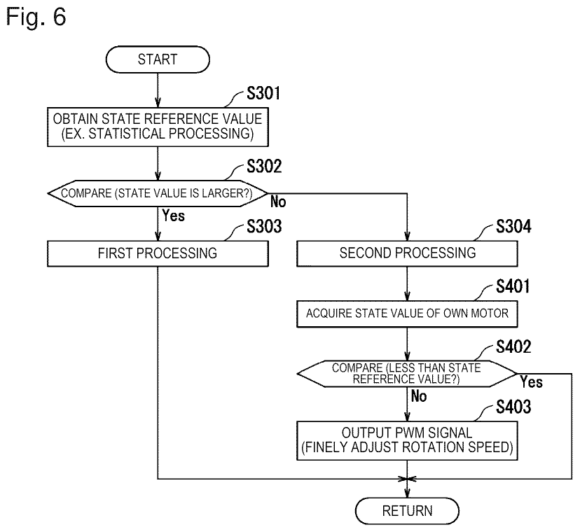

FIG. 6 is a flowchart illustrating a modification of the detailed processing of step S211 illustrated in FIG. 4. Compared with FIG. 5, FIG. 6 is different in that steps S401 to S403 are executed after step S304.

As illustrated in FIG. 6, after the execution of the second processing in step S304, the processing unit 232 acquires the vibration frequency of the own motor 24 after the execution of the second processing as the state value from the corresponding detection unit 235 in step S401.

Next, in step S402, the processing unit 232 determines whether or not the acquired state value is less than the state reference value. As a result, the system 100 can be operated stably. When it is determined that the value is less than the state reference value (Yes in step S402), the processing unit 232 exits the processing of FIG. 6 (that is, step S211 in FIG. 4) and re-executes step S201. On the other hand, when it is determined that the value is not less than the state reference value (No in step S402), step S403 is executed.

In step S403, the processing unit 232 finely adjusts the rotation speed of the own motor 24 based on the PWM signal having the duty ratio based on the deviation between the state value and the state reference value. Thereafter, the processing unit 232 exits the processing of FIG. 6 (that is, step S211 in FIG. 4) of and re-executes step S201.

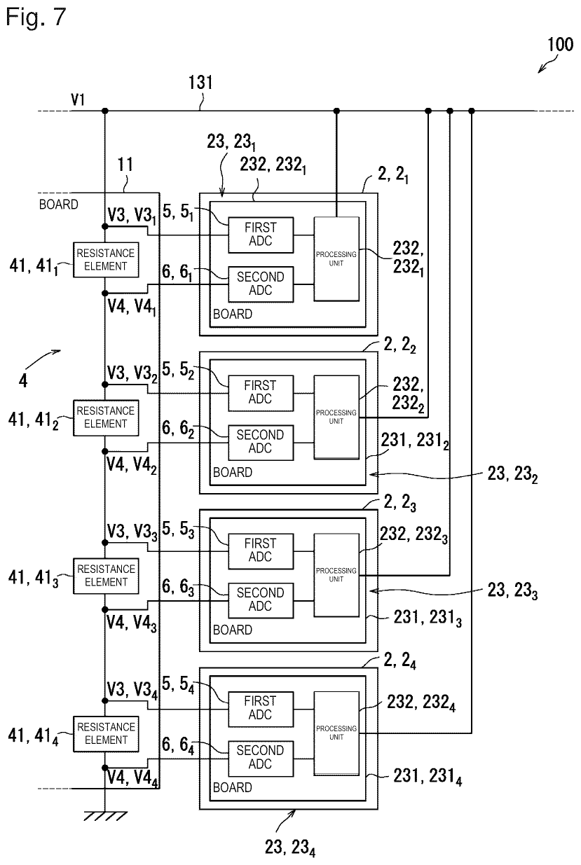

FIG. 7 is a diagram illustrating a first configuration example of a series circuit 4, first ADCs 5, and second ADCs 6 in the system 100 illustrated in FIG. 1. As illustrated in FIG. 7, in addition to the components illustrated in FIGS. 1 and 2, the system 100 further includes the series circuit 4, the plurality of first ADCs 5, and the plurality of second ADCs 6 for setting individual addresses. In FIG. 7, among the components illustrated in FIGS. 1 and 2, the data line 121, the power supply line 132, the communication unit 233, the drive unit 234, the detection unit 235, the motor 24, and the impeller 25 are not shown.

The series circuit 4 is mounted on the board 11 together with the power supply unit 13 (see FIG. 1). The board 11 is an example of a “first board” in the present disclosure. In the embodiment, the series circuit 4 and the power supply unit 13 are mounted on the board 11, and the processing unit 232, the communication unit 233, the drive unit 234, and the detection unit 235 are mounted on the board 231. That is, a plurality of resistance elements 41 are mounted on the same board 11. As a result, the number of steps for mounting the plurality of resistance elements 41 is reduced in the manufacturing process of the system 100.

The series circuit 4 includes the plurality of resistance elements 41. The resistance element 41 is an example of a “resistance” in the present disclosure. All the resistance elements 41 are connected in series. The number of the resistance elements 41 is preferably the same as the number of the motors 24 or the number of the processing units 232. Therefore, the plurality of resistance elements 41 are mounted on the board 11 with a small number of steps.

The resistance values of the respective resistance elements 41 are the same. By making the resistance values the same, the computation processing of individual addresses in the plurality of processing units 232 is simplified.

Each of the plurality of processing units 232 is electrically connected to both ends of resistance elements 41 different from each other by wiring. That is, the system 100 includes the resistance element 41 corresponding to each of the plurality of motors 24.

The power supply unit 13 applies a DC voltage V1 between both ends of the series circuit 4. As a result, information for determining an individual address is given to each of the corresponding processing units 232. The DC voltage V1 is an example of a “constant voltage” in the present disclosure.

Each of the first ADC 5 and the second ADC 6 is an analog-digital converter, and is mounted on the board 231 together with the processing unit 232, for example. Each of the number of the first ADCs 5 and the number of the second ADCs 6 is the same as the number of the motors 24. Therefore, the system 100 includes the first ADC 5 and the second ADC 6 corresponding to each of the plurality of resistance elements 41.

The first ADCs 5 are each arranged on the wiring between one end of the corresponding resistance element 41 (specifically, an upstream end) and the corresponding processing unit 232. The second ADCs 6 are each arranged on the wiring between the other end of the corresponding resistance element 41 (specifically, the downstream end) and the corresponding processing unit 232. Therefore, when the power supply unit 13 applies the DC voltage V1 between both ends of the series circuit 4, each of the first ADCs 5 binarizes the potential difference (hereinafter, referred to as “voltage V3”) between one end of the corresponding resistance element 41 and the ground, and each of the second ADCs 6 binarizes the potential difference (Hereinafter, referred to as “voltage V4”) between the other end of the corresponding resistance element 41 and the ground. Hereinafter, the binarized voltages V3 and V4 are examples of “voltage values” in the present disclosure.

A suffix is added to each of the resistance elements 41 of the series circuit 4 for easy understanding of the following description of the individual address setting process. Specifically, the most upstream resistance element 41 in the series circuit 4 will be referred to as a “resistance element 411”. The second, third, and fourth resistance elements 41 from the most upstream resistance element 411 will be referred to as a “resistance element 412”, a “resistance element 413”, and a “resistance element 414”, respectively. In addition, the processing units 232 corresponding to the “resistance element 411”, the “resistance element 412”, the “resistance element 413”, and the “resistance element 414” are respectively referred to as a “processing unit 2321”, a “processing unit 2322”, a “processing unit 2323”, and a “processing unit 2324”. Similar suffixes are added to the fan 2, the circuit board 23, the board 231, the first ADC 5, the second ADC 6, the voltage V3, and the voltage V4.

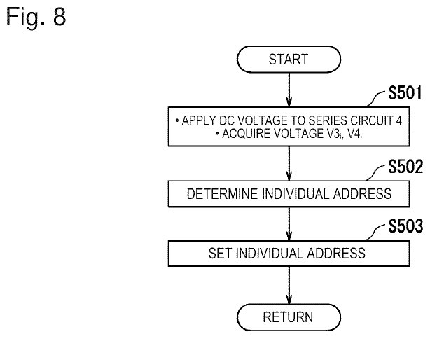

FIG. 8 is a flowchart illustrating individual address setting processing in the system 100 illustrated in FIG. 7. In a case where the information processing apparatus 200 is activated for the first time after factory shipment for example, the processing of FIG. 8 is executed. As shown in step S501, the power supply unit 13 applies the DC voltage V1 between both ends of the series circuit 4. As a result, the processing unit 232: acquires the voltage V3; from the first ADC 5; and the voltage V4; from the second ADC 61. i represents any of 1, 2, 3, and 4.

Next, in step S502, the processing unit 232; determines a unique individual address in the processing unit 2321 to 2324 on the basis of the DC voltage V1, the voltages V3ᵢ and V4ᵢ, and the voltage (V3ᵢ-V4ᵢ) between the both ends of the resistance element 411. By determining the individual address in this manner, it is not necessary to set an individual address for each fan 2 in the manufacturing process of the system 100. Moreover, in the system 100, the fans 2 are identical to each other. Thus, the system 100 can be manufactured at low cost.

In step S502, more specifically, the processing unit 232; determines a value derived by the following Expression (1) as its own individual address.

$$Individual address of processing unit {232}_{i} = ( V 1 - V {4}_{i} ) / ( V {3}_{i} - V {4}_{i} ) \qquad ( 1 )$$

In step S503, the processing unit 232; sets the individual address obtained in step S502 in its own register.

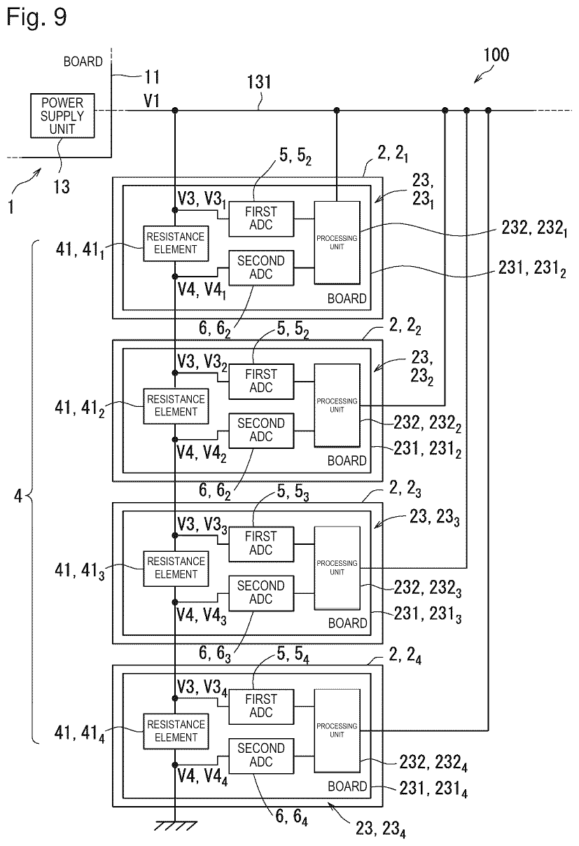

FIG. 9 is a diagram illustrating a modification of the series circuit 4 in the system 100 illustrated in FIG. 1. As illustrated in FIG. 9, in the series circuit 4, each resistance element 41 is mounted on the corresponding board 231 together with the corresponding processing unit 232, the communication unit 233, the drive unit 234, and the detection unit 235. As a result, since an increase in size of the board 11 is suppressed in comparison with the configuration of FIG. 7, the degree of freedom in arrangement of each component in the housing 201 (see FIG. 1) is improved.

The embodiment of the present disclosure is described above with reference to the drawings. However, the present disclosure is not limited to the above embodiment, and can be implemented in various modes without departing from the gist of the present disclosure. Further, a plurality of constituent elements disclosed in the above embodiment can be appropriately modified. For example, a certain constituent element of all constituent elements illustrated in a certain embodiment may be added to constituent elements of another embodiment, or some constituent elements of all constituent elements illustrated in a certain embodiment may be removed from the embodiment.

The drawings schematically show each component mainly in order to facilitate understanding of the present disclosure, and the thickness, length, number, interval, and the like of each component that is shown may be different from the actual ones for convenience of the drawings. The configuration of each component shown in the above embodiment is an example and is not particularly limited, and it goes without saying that various modifications can be made without substantially departing from the effects of the present disclosure.

In the embodiment, the case where the system 100 is applied to the information processing apparatus 200 has been described. However, the present invention is not limited thereto, and the system 100 may be applied to a roller conveyor. A roller conveyor is a device in which a plurality of rotating bodies (rollers) are arranged and fixed at a right angle between a pair of frames, and a conveyance object is placed and moved on the plurality of rotating bodies. In this case, not the impeller 25 but a roller is attached to the output shaft of each motor 24.

In the embodiment, data communication based on the I2C has been performed in the system 100. However, the data communication may be performed by a communication protocol other than the I2C.

In the embodiment, in the system 100, the communication unit 233 transmits data to the other communication unit 233 via the control unit 12 as a master. However, the present invention is not limited thereto, and in a case where the slave-to-slave communication can be executed, the communication unit 233 may directly transmit data to another communication unit 233.

In the embodiment, a state reference value based on the statistical process is obtained in step S211. However, the present invention is not limited thereto, and the state reference value may be one selected from the state values of the other motors 24 included in the second notification.

In the embodiment, for setting the individual address, the system 100 includes the series circuit 4, the first ADC 5, and the second ADC 6. However, the present invention is not limited thereto, and the system 100 may use a MAC address allocated in advance to the communication unit 233 as the individual address.

In the embodiment, as illustrated in FIG. 7, the series circuit 4 and the power supply unit 13 are mounted on the board 11, and the processing unit 232, the communication unit 233, the drive unit 234, and the detection unit 235 are mounted on the board 231. However, the present invention is not limited thereto, and at least one of the series circuit 4 and the power supply unit 13 may be mounted on the board 11.

In the embodiment, as illustrated in FIG. 9, each of the resistance elements 41 in the series circuit 4 is mounted on the corresponding board 231. However, the present invention is not limited thereto, and at least one of the resistance element 41 and the power supply unit 13 in the series circuit 4 may be mounted on the board 231.

In addition, the data line 121 and the power supply lines 131 and 132 may be accommodated in the housing. In this case, the circuit board 1 and each fan 2 are connected to the data line 121 and the power supply line 131 and 132 by a connector (not illustrated) provided in the housing. In addition, the data line 121 and the power supply lines 131 and 132 may be accommodated in a plurality of housings. In this case, the circuit board 1 and each fan 2 are connected to the data line 121 and the power supply lines 131 and 132 by a connector (not illustrated) provided in the housing, and the plurality of housings are also connected to each other by a connector (not illustrated) provided in the housing.

The present technology can also adopt the following configurations.

(1) A system including:
a plurality of motors; and
a detection unit, a communication unit, and a drive unit corresponding to each of the plurality of motors,
in which the detection unit detects a state of an own motor, the own motor being one of the plurality of motors corresponding to the detection unit,
the communication unit transmits a state of the own motor to another communication unit and receives a state of another motor from the other communication unit, the other motor being one of the plurality of motors corresponding to the other communication unit, and
the drive unit rotates the own motor at a rotation speed based on the state of the other motor received by the communication unit corresponding to the drive unit.

(2) The system according to (1), further including an impeller attached to an output shaft of each of the plurality of motors.

(3) The system according to (1) or (2), in which the detection unit detects at least one of a rotation speed, a current, vibration, and temperature as the state of the own motor.

(4) The system according to any one of (1) to (3), further including a processing unit corresponding to each of the plurality of motors,
in which the processing unit executes processing for increasing or decreasing a rotation speed of the motor corresponding to the processing unit on a basis of the state of the other motor and the state of the own motor.

(5) The system according to (4), in which
the detection unit outputs a state value that is a value indicating the state of the own motor, to the processing unit corresponding to the detection unit, and
the processing unit compares the state value with a state reference value, the state reference value being determined based on statistical processing on the state values of a plurality of the other motors. (6) The system according to (5), in which the processing unit:
   executes first processing for decreasing the rotation speed of the own motor when the state value is larger than the state reference value, and
   executes second processing for increasing the rotation speed of the own motor when the state value is smaller than the state reference value.

(7) The system according to (6), in which
the state value includes a vibration frequency of the own motor, and
the processing unit determines whether or not the vibration frequency is less than a vibration reference value after execution of the second processing.

(8) The system according to (6), in which
a first processing unit that is at least one of a plurality of the processing units executes the first processing for decreasing the rotation speed of the own motor,
a second processing unit that is at least one of the plurality of processing units excluding the first processing unit executes the second processing for increasing the rotation speed of the own motor in response to execution of the first processing by the first processing unit, and
the rotation speed of the own motor increased by the second processing unit is determined based on the rotation speed of the own motor decreased by the first processing unit.

(9) The system according to any one of (4) to (8), in which the detection unit, the communication unit, the drive unit, and the processing unit are incorporated in a same integrated circuit.

(10) The system according to any one of (1) to (9), in which the state of the own motor is transmitted through a wireless transmission path, and the state of the other motor is received through the wireless transmission path.

(11) The system according to any one of (1) to (3), further including:
a processing unit corresponding to each of the plurality of motors;
a series circuit in which a plurality of resistors are connected in series; and
a power supply unit that applies a constant voltage between both ends of the series circuit,
in which a number of the resistors is same as a number of the plurality of motors, and
a plurality of the processing units are each electrically connected to both ends of each of the plurality of resistors different from each other.

(12) The system according to (11), in which each of the plurality of processing units determines unique identification information in the plurality of processing units, on a basis of the constant voltage and an end-to-end voltage of each of the plurality of resistors connected to each of the plurality of processing units.

(13) The system according to (11) or (12), further including a first ADC and a second ADC corresponding to each of the plurality of resistors,
in which the first ADC binarizes a voltage value at one end of one of the plurality of resistors corresponding to the first ADC,
the second ADC binarizes a voltage value of another end of one of the plurality of resistors corresponding to the second ADC, and
each of the plurality of processing units determines the identification information based on the constant voltage and a binarized end-to-end voltage that is a voltage across each of the plurality of resistors corresponding to each of the plurality of processing units.

(14) The system according to any one of (11) to (13), in which the plurality of resistors have a same resistance value.

(15) The system according to any one of (11) to (14), further including:
a first board on which at least one of the power supply unit and the series circuit is mounted; and
a second board on which the motor, the detection unit, the communication unit, and the drive unit are mounted.

(16) The system according to any one of (11) to (14), further including a board on which at least one of the power supply unit and the series circuit, and the motor, the detection unit, the communication unit, and the drive unit are mounted.

The system according to the present disclosure has industrial applicability.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A system comprising:
a plurality of motors; and
a detection unit, a communication unit, and a drive unit corresponding to each of the plurality of motors,
wherein the detection unit detects a state of an own motor, the own motor being one of the plurality of motors corresponding to the detection unit,
the communication unit transmits a state of the own motor to another communication unit and receives a state of another motor from the other communication unit, the other motor being one of the plurality of motors corresponding to the other communication unit, and
the drive unit rotates the own motor at a rotation speed based on the state of the other motor received by the communication unit corresponding to the drive unit.

2. The system according to claim 1, further comprising an impeller attached to an output shaft of each of the plurality of motors.

3. The system according to claim 1, wherein the detection unit detects at least one of a rotation speed, a current, vibration, and temperature as the state of the own motor.

4. The system according to claim 1, further comprising a processing unit corresponding to each of the plurality of motors,
wherein the processing unit executes processing for increasing or decreasing a rotation speed of the motor corresponding to the processing unit on a basis of the state of the other motor and the state of the own motor.

5. The system according to claim 4, wherein
the detection unit outputs a state value that is a value indicating the state of the own motor, to the processing unit corresponding to the detection unit, and
the processing unit compares the state value with a state reference value, the state reference value being determined based on statistical processing on the state values of a plurality of the other motors.

6. The system according to claim 5, wherein
the processing unit:
executes first processing for decreasing the rotation speed of the own motor when the state value is larger than the state reference value, and
executes second processing for increasing the rotation speed of the own motor when the state value is smaller than the state reference value.

7. The system according to claim 6, wherein
the state value includes a vibration frequency of the own motor, and
the processing unit determines whether or not the vibration frequency is less than a vibration reference value after execution of the second processing.

8. The system according to claim 6, wherein
a first processing unit that is at least one of a plurality of the processing units executes the first processing for decreasing the rotation speed of the own motor,
a second processing unit that is at least one of the plurality of processing units excluding the first processing unit executes the second processing for increasing the rotation speed of the own motor in response to execution of the first processing by the first processing unit, and
the rotation speed of the own motor increased by the second processing unit is determined based on the rotation speed of the own motor decreased by the first processing unit.

9. The system according to claim 4, wherein the detection unit, the communication unit, the drive unit, and the processing unit are incorporated in a same integrated circuit.

10. The system according to claim 1, wherein the state of the own motor is transmitted through a wireless transmission path, and the state of the other motor is received through the wireless transmission path.

11. The system according to claim 1, further comprising:
a processing unit corresponding to each of the plurality of motors;
a series circuit in which a plurality of resistors are connected in series; and
a power supply unit that applies a constant voltage between both ends of the series circuit,
wherein a number of the resistors is same as a number of the plurality of motors, and
a plurality of the processing units are each electrically connected to both ends of each of the plurality of resistors different from each other.

12. The system according to claim 11, wherein each of the plurality of processing units determines unique identification information in the plurality of processing units, on a basis of the constant voltage and an end-to-end voltage of one of the plurality of resistors connected to each of the plurality of processing units.

13. The system according to claim 12, further comprising a first ADC and a second ADC corresponding to each of the plurality of resistors,
wherein the first ADC binarizes a voltage value at one end of one of the plurality of resistors corresponding to the first ADC,
the second ADC binarizes a voltage value of another end of one of the plurality of resistors corresponding to the second ADC, and
each of the plurality of processing units determines the identification information based on the constant voltage and a binarized end-to-end voltage that is a voltage across each of the plurality of resistors corresponding to each of the plurality of processing units.

14. The system according to claim 11, wherein the plurality of resistors have a same resistance value.

15. The system according to claim 11, further comprising:
a first board on which at least one of the power supply unit and the series circuit is mounted; and
a second board on which the processing unit, the detection unit, the communication unit, and the drive unit are mounted.

16. The system according to claim 11, further comprising a board on which at least one of the power supply unit and the series circuit, and the processing unit, the detection unit, the communication unit, and the drive unit are mounted.
